(19) United States
(12) Patent Application Publication
(10) Pub. No.: US 2014/0096042 A1
(43) Pub. Date: Apr. 3, 2014

(54) METHOD AND SYSTEM FOR GENERATING AND STORING A COLLECTION OF INTERACTIVE BROWSERS WITHIN A NAVIGATION PLANE

(71) Applicant: Aaron Tyler Travis, New York, NY (US)

(72) Inventor: Aaron Tyler Travis, New York, NY (US)

(73) Assignee: Aaron Tyler Travis, New York, NY (US)

(21) Appl. No.: 13/936,484

(22) Filed: Jul. 8, 2013

Related U.S. Application Data
(60) Provisional application No. 61/669,642, filed on Jul. 9, 2012.

(30) Foreign Application Priority Data
Jul. 8, 2013 (US) 13936484

(51) Int. Cl. G06F 3/0484

(52) U.S. Cl. CPC G06F 3/0484
USPC 715/760

(57) ABSTRACT

A system allowing for the creation of a multitude of interactive browsers within a single navigation container, each browser being capable of displaying a remote or local document in keeping with the behavior of internet browsers known in the art. If the container becomes larger than the computer system's display area can accommodate, the user may use scrolling, scaling, zooming or other navigation methods to adjust the visible area of the container so as to view each browser. In a further embodiment, the system allows for storage of the browsers as a collection such that the layout of browsers and documents loaded therein could be recreated in another session. In a further embodiment, the collection would be sharable with other persons or computers. In another embodiment, the collection would allow for personalized data, such as title and notes, to be appended.

Embodiments of the invention can be accomplished in a number of locations and manners, including but not limited to documents, software applications, operating systems or any other technological function or method.

### RELATED APPLICATIONS

This application is a continuation of and claims priority to U.S. patent application Ser. No. 61/669,642, filed on Jul. 9, 2012, the disclosure of which is incorporated by reference herein.

### FIELD OF THE INVENTION

The present invention is in the field of Internet/web browser technology and, in particular, to a multiple window browser interface and improved system and method for generating the same.

### DESCRIPTION OF THE RELATED ART

Presently, browser applications, such as Microsoft Internet Explorer, Mozilla Firefox and Google Chrome provide functionality for users to receive content via the World Wide Web (referred to herein as the “web”) or the Internet. As is well known in the art, browser applications typically provide a graphical user interface (or GUI) that enables users to view text or graphic based web sites.

Those skilled in the art will know that the term “browser” can be applied to any program capable of displaying and/or editing a document. For the purpose of description, the term “document” can mean an internet-enabled document, a.k.a web page. Conversely, a web page can also refer to any document, whether internet-enabled or not. Further, modern browsers are capable of hosting software applications and extensions that previously were only possible outside of the browser. Thus, these terms “web page, web site, software application (a.k.a “App”), extension and document” as referred to herein should be used interchangeably.

### One Website at a Time

In the most common state of the art, browsers display one document at a time. However, it is common in the process of Internet usage to need to view more than one document. To accomplish this, many browsers employ a “tab” paradigm to allow for more than one document to remain open in the browser. Each document is represented as a separate tab. One may switch between tabs to view corresponding documents contained therein. However, this system generally allows for only one tab/document to be viewed at a time.

Should the need arise to view documents in side-by-side fashion, multiple instances of the browsers can be created and moved within a typical windowed computer operating system, such as Microsoft Windows or Apple Mac OS. While this allows for two or more document to be viewed at once, the limited screen size of computers generally limits the frame size, and thus visible area of each document. To see any covered areas of a document, the user must engage with scrollbars or other apparatus to move the document around within the frame.

Portal Websites

To make the aggregation of content from multiple sources easier, some documents are known in the art as “Portals” which bring together components of content sometimes referred to as “portlets” or “modules.” In this embodiment, a document is divided into smaller components, each of which having content that is fed into it by a specified source. In this manner, one document can accommodate data from many sources while still fitting into the area of screen equivalent to only one document. However, a limitation of this format is that content must be specially formatted to fit into the size of these portals, meaning that since much of the Internet is unformatted, it is thus incompatible.

### Multiple Website Views—Scrollbar Problems

A known function in the art of Internet documents is that of an iFrame, which allows an external document to appear inside another document. This method is frequently used to display portions of Internet content within documents. However, because web sites vary in size, it becomes necessary to display and engage in scrollbars to view the entirety of a web page. The heavy use of scrollbars is generally not preferable to users. It may also be incompatible with mobile browsers and can cause disruptions in scrolling when using a wheel mouse (a computer navigation peripheral that allows for the scrolling of content without having to engage with scrollbars.)

### Screen Dividers

One solution in use in the industry for displaying multiple pages is to divide the browser into multiple “panels.” Each panel takes up a portion of the available space, and uses scrollbars if necessary to allow for viewing of covered portions of a document. However, as this solution reduces the screen size available for each document, it thus reduces the amount of each document that is visible. Further, there is a finite number of times that the screen can be divided before each panel becomes too small to be useful.

### Saved Sessions

When viewing multiple web pages, it may be necessary to retain the set of open documents for use later. For example, when planning a trip, it may be necessary to have many windows available showing maps, location details, travel itineraries, price comparisons, etc. At a minimum, most browsers allow for the storage of a single website location for later viewing, aka “bookmarking.” However, each bookmark contains the location for only one web document. This means that each document would have to be separately bookmarked, and reopened one at a time in order to recreate a previous browsing session.

A few browsers allow for a currently open set of tabs to be saved for later recreation of the browsing session. When this function is initiated, the previous set of tabs opens in the previous order, with each tab's corresponding document loaded.

### Share Open Sites

The aforementioned saving of tabbed browsing sessions can provide a valuable resource for an individual browser, but it does not allow for the sharing of that session to others who might want to use it. For example, say one family member completes a browsing session in the aforementioned example of planning a trip. That family member wishes to send that session to the computers belonging to other family members for their feedback and approval. This would not be possible in the current state of the art.

### Share Links

To accommodate the sharing of multiple pages, there exists in the art “link bundling” services, whose purpose is to take a multitude of links and compile a list in one location. These services facilitate the creation of a single document containing a list of links to other documents, which can then be shared. However, the receiver of such a list must actively engage all links in the list to sufficiently recreate the session of open web pages.

### Personalized Data

In the aforementioned link bundling service, the creator of the bundle can append personalized data to the bundle, such as a bundle name, notes about each link, etc. A similar type of bundle could be created by simply typing a list into an email and sending it to chosen parties. However, such personalized data would exist only in the list, and as such the user would have to refer back and forth between the list and the browser session if both are needed at the same time.

What is needed is a system allowing for the simultaneous viewing of a multitude of interactive browsers. In a further benefit, the system should allow for storage of the multitude of documents and their current state as a collection. In an even further benefit, the collection would be sharable with other persons or computers users such that the collection of open documents could be recreated in another session on a different computer, browser, or session of the same browser. In a final further benefit, personalized data could be appended to the collection.

### SUMMARY OF THE INVENTION

In an embodiment of the invention, a container is created which allows for a user to create a multitude of inner browsers contained in said container, each capable of displaying a document. This system is enhanced through any number of the following features:

### Viewer Management

Inner browsers may be replicable, meaning that the user can add new viewers as needed, barring any limitations placed on the system. Inner browsers can also be removed at will in order to save space, remove unneeded documents or to reduce computer system load. Further, viewers can be duplicated to create a copy of the currently displayed document view.

When generating a multitude of inner browsers, it is likely that the size of a viewer's screen will become a limitation to viewing all of said viewers. To facilitate the navigation of a multitude of inner browsers that lie outside of the visible area of the screen, it may be helpful to link the movement of all inner browsers in the same navigational container, such that when a user navigates through the container, the inner browsers move in a substantially synchronous fashion in any combination of vertical and horizontal directions.

In additional embodiment, inner browsers may automatically grow in size to accommodate the full size of the enclosed document, thereby negating the need to display scroll bars to reveal hidden areas of the document. In this manner, the problems in navigation outlined in related art regarding the presence of scrollbars can be avoided.

With a multitude of inner browsers open, it may be helpful to allow for certain features to manage the collection. This could include the ability to “minimize” inner browsers, meaning that they can be shrunk in size to allow other inner browsers to take up more available screen real estate. This function would be accompanied by the ability to “maximize,” or restore them to their previous size. Further, the size of the inner browsers could be freely adjustable to a desired size by the user. Such functionality could allow for the “cropping” of a document, meaning that the size of the containing browser is reduced such less than the full area of the contained document is visible.

Another feature to facilitate the management of inner browsers is the ability to rearrange them. This includes but is not limited to “drag and drop” (using an interaction apparatus to move the inner browser to a desired position) or swapping of the position of two or more inner browsers.

In another embodiment, it would be possible for links accessed in one inner browser to open in either a new or different inner browser. The most obvious use for this being that there is a list of links to explore in one inner browser, such as in a search results page, and they can be accessed without having to navigate away from said list.

In another embodiment, the system would recognize which URL the user arrived from, as in a different web site, and allow the user to load said web site into one of the inner browsers. In this manner, a user could seamlessly transition from viewing a single web page into the present embodiment's multi-document viewer environment.

In a preferable enhancement of the aforementioned methods, said inner browsers could be optionally grouped in an overlapping tabbed format, such that each inner browser represents one tab, as opposed to the inner browsers being spread apart in non-overlapping, coplanar fashion. The process could then be undone by user action.

In one embodiment of the invention, each inner browser would contain controls necessary for the navigation and any other utilization of said inner browser.

In another embodiment of the invention, the controls for inner browser would be located in a single location. The target that the controls interact with may change depending on circumstances within the application. For example, an inner browser may be “selected” meaning that that inner browser is chosen to be the sole recipient of said controls.

In another embodiment, tabs located outside of the navigation container indicate the contents of corresponding inner browsers. The tabs have an interaction with the navigation container, such that engaging a tab will cause the corresponding inner browser to come into view

In another embodiment, tabs located outside of the navigation container indicate the contents of corresponding inner browsers. The tabs have an interaction with the navigation container, such that adjusting the view of the navigation container affects the tabs. For example, bringing an inner browser to the center of the navigation container may cause the corresponding tab to activate in some way.

### Document Display

Inner browsers posses functions that facilitate their ability to display documents. This includes, but is not limited to the features described herein.

Inner browsers are capable of loading a document from a specified location, whether from a location on a network or locally on a device. In a further embodiment, the location of said document is displayed to the user. For the purposes of identifying remote documents, this location typically is shown as a Uniform Resource Locator, or URL.

The static nature of many web pages leads to the desire for the ability to easily “refresh” the page, meaning that the same document is loaded again so as to update it if any changes have been made since the last download. This refresh ability is typically, but not necessarily engaged via a button.

Because each inner browser is capable of viewing a sequence of documents, such as when engaging a series of hyperlinks, a useful feature allows for the inner browser to go “Back” meaning displaying previously loaded documents in reverse chronology. A further useful feature allows the inner browser to travel “Forward” meaning loading documents in forward chronological order after already travelling backward. Such a record of site traveled may be stored as a “history.”

While downloading a document, it is helpful to display the status of the download to the user. This generally comes in two forms. In one form, a simple message or graphic displays while the download is taking place, and is then removed what the download completes. In another form, an indicator of the progress of the total download is displayed; giving a more accurate indication of the proportion of the download that has already taken place.

To facilitate rapid information retrieval, an inner browser may display a search function in an easily accessible location. This may take the form of a “search box” which is a text box allowing for the entry of search terms, typically accompanied by a button that initiates the search.

An additional helpful feature allows documents contained in inner browsers to be opened in a different window instance or tab of the parent browser.

It should be noted that the inner browsers described herein should contain a multitude of additional functions known in the art to be standard to browsers at large, including but not limited to Save, Save As, Print, View Page Source, etc.

As is known in the art, browsers most commonly allow for the “bookmarking” of web documents, referring to the saving of location shortcuts to documents for later viewing. In an embodiment, the inner browsers described herein allow for both bookmarking and the retrieval of bookmarks. This functionality may be present at the level of each individual viewer, at the level of the collection of viewers, and/or at the level of a user of said system.

A useful feature offered by many browsers known in the art is the ability to store and access a page “History,” or record of pages visited. In this manner, users can easily return to a document that they have visited in the past. In as in the bookmarking functionality, this history can be collected at the level of each individual viewer, at the level of the collection of viewers, and/or at the level of a user of said system.

### Collection

As described in related art, documents are typically viewed independently of each other, one at a time. In an embodiment, the display of document browsers could be treated as a single “Collection,” meaning that the collection can be saved and retrieved together. The facilitation of this functionality is aided by any number of the following components:

To store and recreate the Collection described previously, data must be collected and saved. This can be handled in a number of ways known to the art, including but not limited to text strings containing parameters, storage in a database, local cookies and more.

In an embodiment, the Collection-level could contain data, including but not limited to Collection name, descriptive text, notes, images, backgrounds, history, and more.

In a further preferred embodiment, the Collection could be transmitted, such that it could be accessed or recreated in another browser session or computer, by the creator of the Collection or others.

In an even further preferred embodiment, said collection could be accessed and/or edited by multiple persons or methods either simultaneously or asynchronously. In this manner, the Collection becomes a shared entity.

If Collection data is transmitted via a parameterized URL, it would be beneficial to apply URL-shortening technology, as is known in the field.

If said Collections could be shared with other parties, an additional preferred embodiment would allow the creator of a Collection to control the level of access to said collection for public consumption.

If access to a Collection is granted to users beyond just the creator, an embodiment would allow those users to comment on, share or edit said collection.

To make usage of said Collection easier, a consolidated “Table of Contents” may be automatically created, which lists out current inner browsers. This is particularly useful where there are more inner browsers than can fit on the screen. Thus, a user may quickly understand what documents are available without having to fully navigate the collection. In a further preferred embodiment, said Table of Contents would allow for user-initiated actions to take the user to the selected viewer, thus allowing for shortcut navigation to jump directly to the chosen inner browser. In an even further preferred embodiment, the table of contents would have functionality to enable editing of the collection, including but not limited to reordering, resizing and closing of viewers.

As previously mentioned, each inner browser could have a respective search function. However, it would be equally possible to place a search function at the level of the Collection. In all cases, it may be preferable to allow for users to search an individual web site, all web sites that are currently being viewed in the Collection and/or the entire internet.

### Technology

Embodiments of the invention can be accomplished in a number of locations and manners, including but not limited to documents, software applications, operating systems or any other technological function or method.

Note that the scope of present embodiment should include any software or enhancements to other software that facilitates the functionality described herein. This includes, but not limited to new browser software or enhancements to browsers software. Those skilled in the art will know that software that is created to facilitate the present embodiment may have advantages such as speed, stability, access to hardware functions and more.

In a further benefit to a software-enhanced version of the present embodiment, the software would recognize the loading of a document containing the described features of the present embodiment and automatically engage certain enhancements.

An embodiment would be able to convert all or part of a browsing session, such as those contained in a series of tabs, into a collection. This collection could then be shared and/or accessed using the presently described system.

It is also obvious to those skilled in the art that security measures should be taken to prevent any malicious activity or effects that may stem from the simultaneous usage of multiple web sites. Efforts should me taken to mitigate access to information or functions between documents.

### BRIEF DESCRIPTION OF THE DRAWINGS

### Related Art

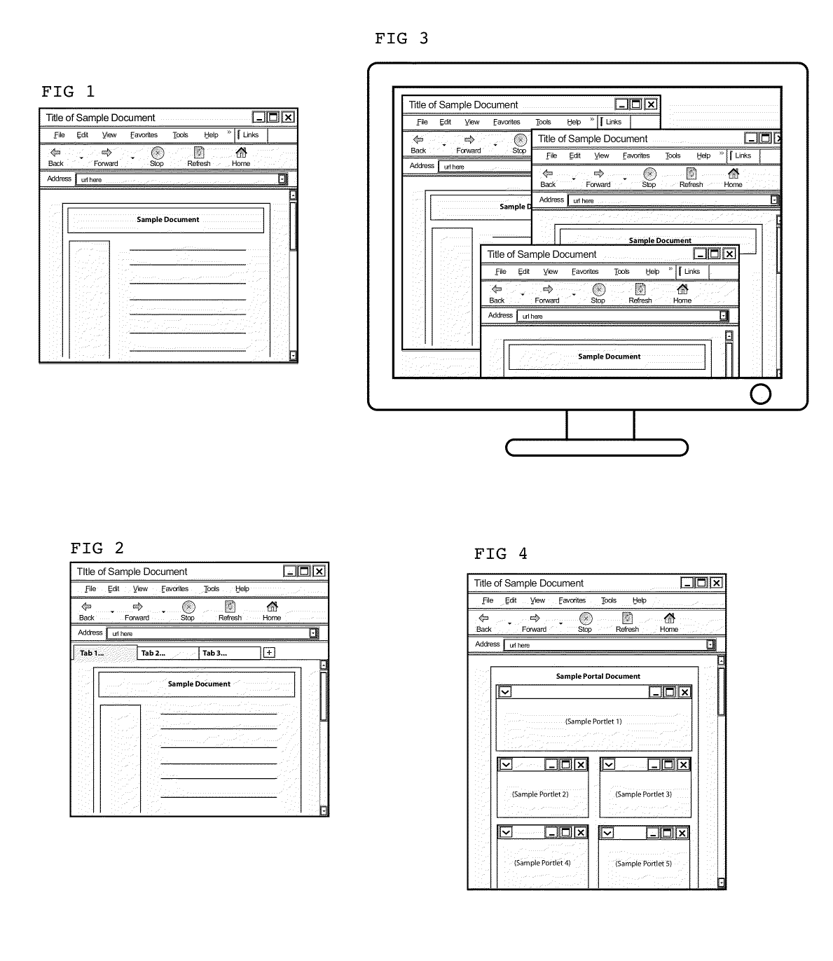

FIG. 1: Typical browser showing one open document

FIG. 2: Browser showing multiple documents open, each document being represented as a tab

FIG. 3: A computer monitor displaying employing a “windowed” operating system as known in the art, such as Microsoft Windows or Apple Macintosh. Multiple browsers are open, and overlap each other

FIG. 4: A “portal” style web page containing a number of “modules.” The modules are capable of displaying content from various sources

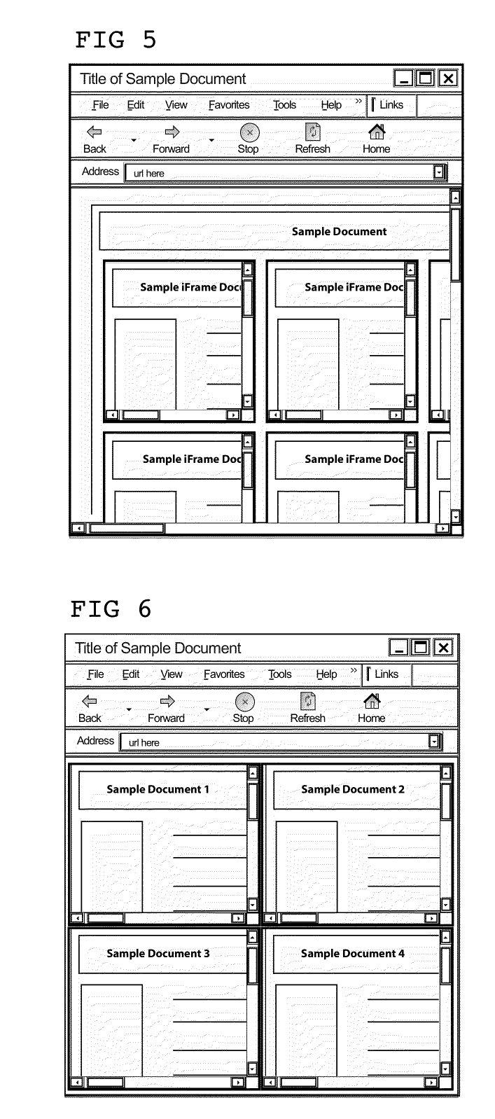

FIG. 5: An HTML web document showing full-sized external web pages loaded into frames. Because the external pages do not fit into the allowed space, scroll bars are needed

FIG. 6: A browser whose document-viewing area has been divided to allow for a different document to be loaded in each subdivision

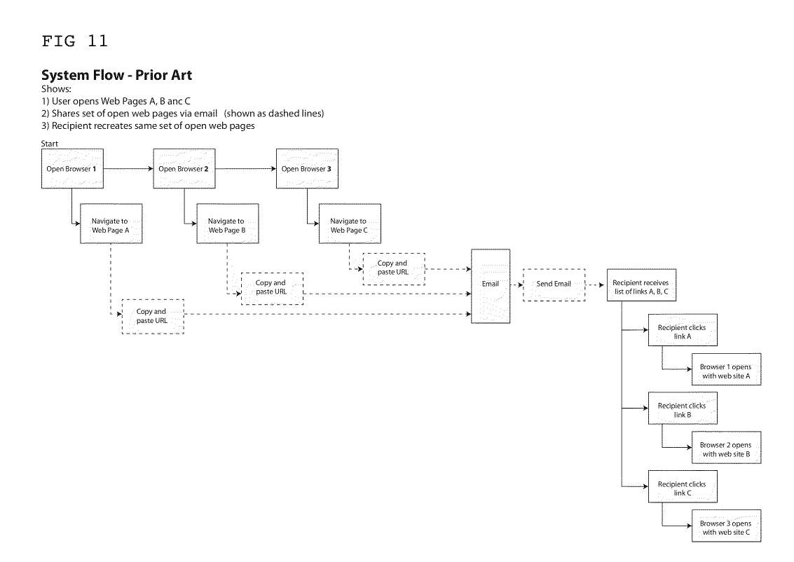

FIG. 11: A system flow using related art, showing how 1) a user would open example web pages A, B and C; 2) the same user would send links to those pages to a recipient via email; and 3) recipient of said email would open web pages A, B, and C

### Embodiments of the Invention

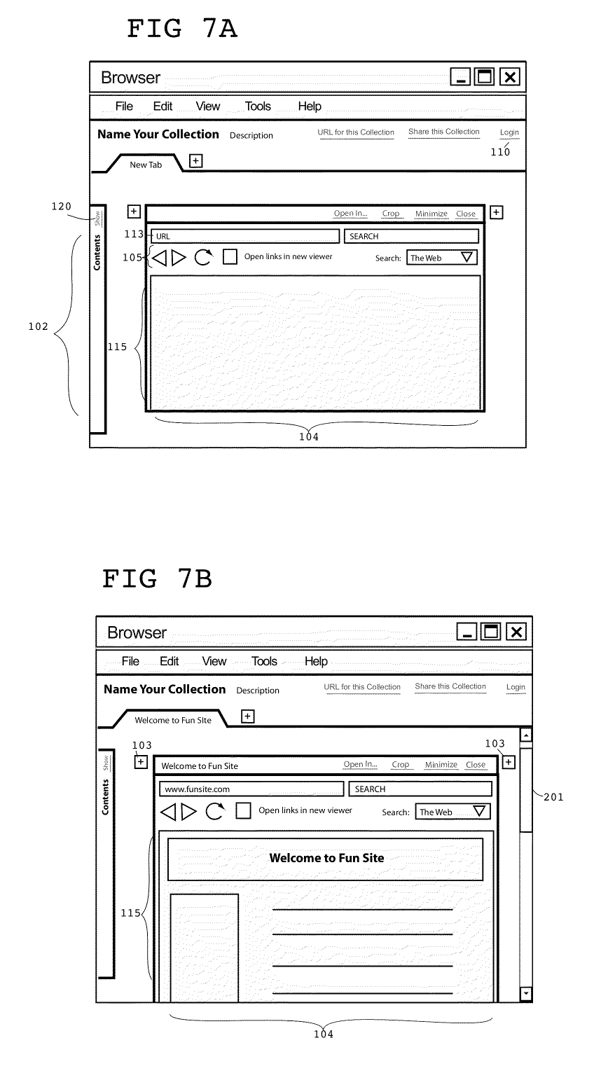

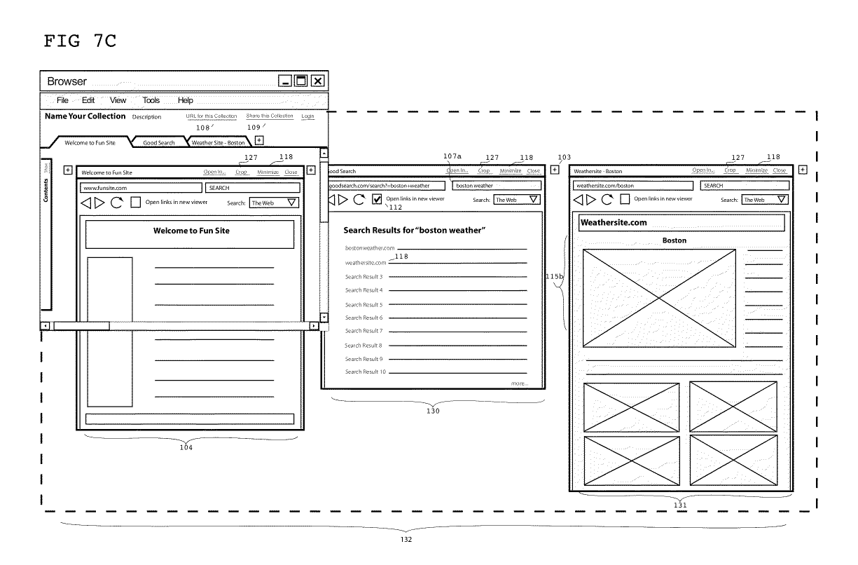

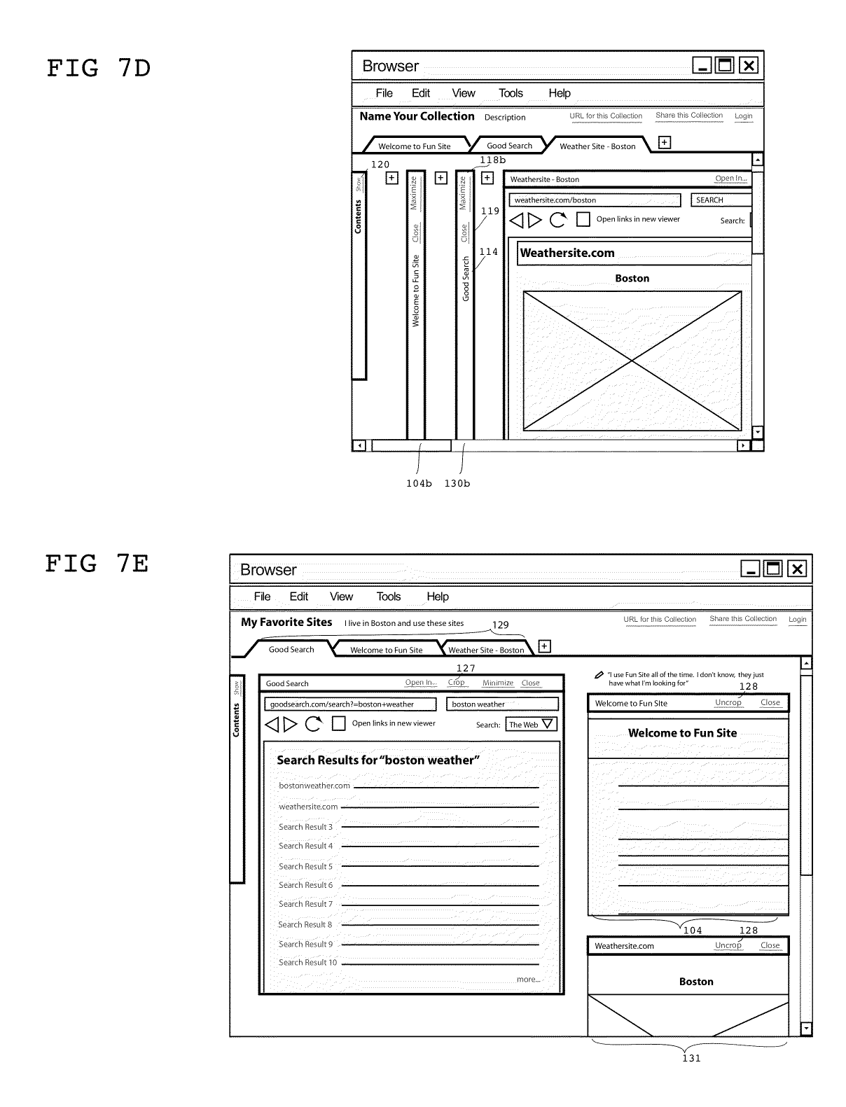

FIG. 7A: Browser with a single document loaded containing the present embodiment. One inner browser is open, without a document loaded

FIG. 7B: The same as FIG. 7A but with a document loaded into said inner browser

FIG. 7C: The same as FIG. 7B but with two additional inner browsers open, each containing a document

FIG. 7D: The same as FIG. 7C but with two inner browsers changed to a “collapsed” state

FIG. 7E: The same as FIG. 7C but with two inner browsers changed to a “cropped” state and repositioned into a vertical alignment

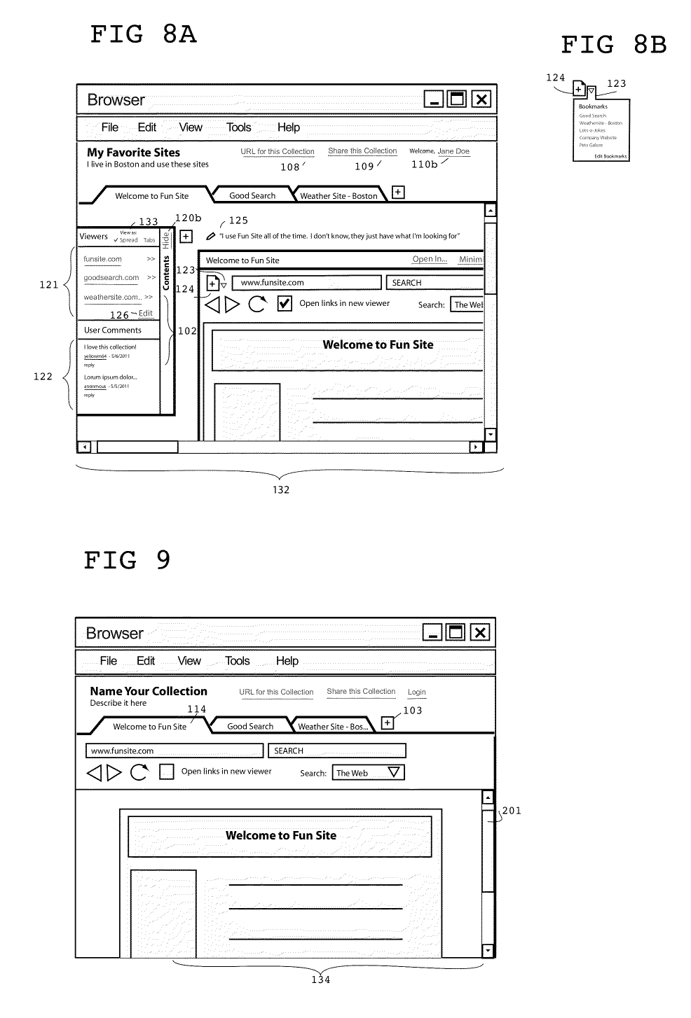

FIG. 8A: The present embodiment shown with a table of contents panel expanded

FIG. 8B: A menu that could be visible upon engaging a “bookmarking” function on an inner browser

FIG. 9: Alternate state of viewing inner browsers as tabs, rather than spaced out in non-overlapping fashion.

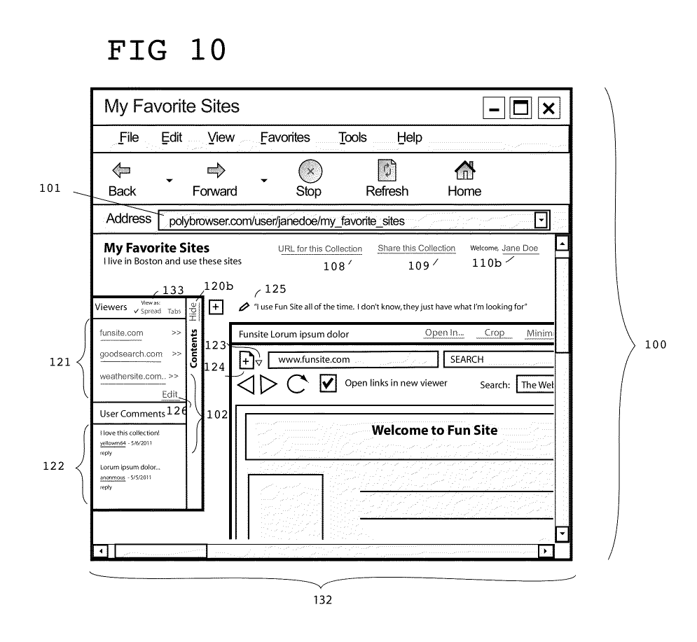

FIG. 10: An embodiment wherein the invention is shown within a document (web page) loaded in a standard or otherwise invention-enabled browser.

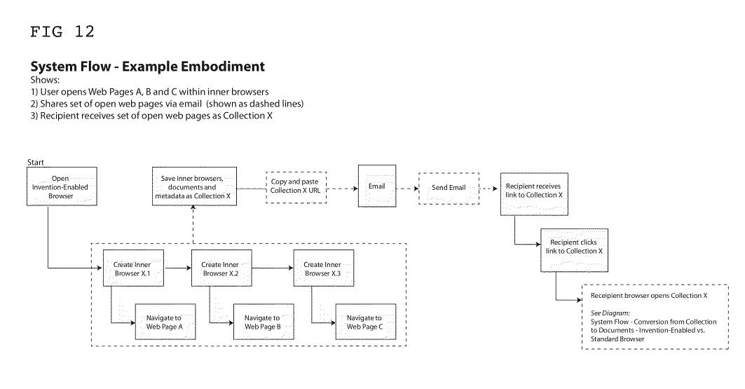

FIG. 12: A system flow using the preferred embodiment, showing how 1) a user would open example web pages A, B and C; 2) the same user would send links to those pages to a recipient via email; and 3) recipient of said email would open one web page, containing inner browsers showing web pages A, B and C

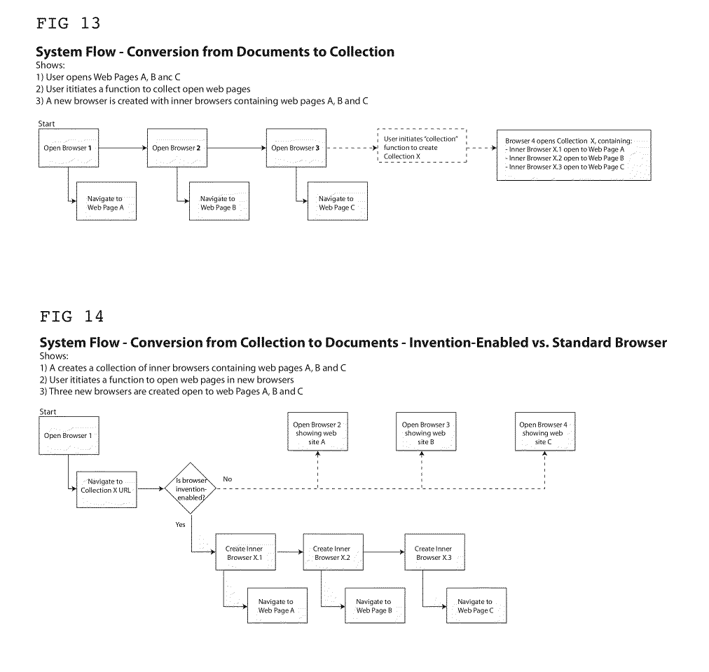

FIG. 13: A system flow wherein currently open browsers are converted into an equivalent set of inner browsers inside a collection described in the present embodiment.

FIG. 14: A system wherein the web pages contained in a collection of inner browsers described in the present embodiment are converted into separate standard browsers.

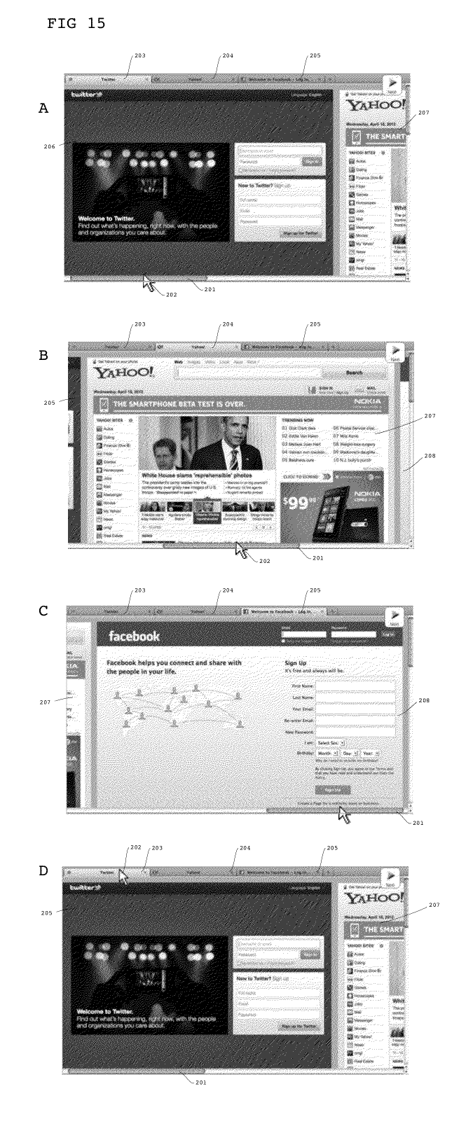

FIG. 15: A sequence of 4 panels showing an embodiment of the invention which illustrates a possible interaction between tabs and the navigation container

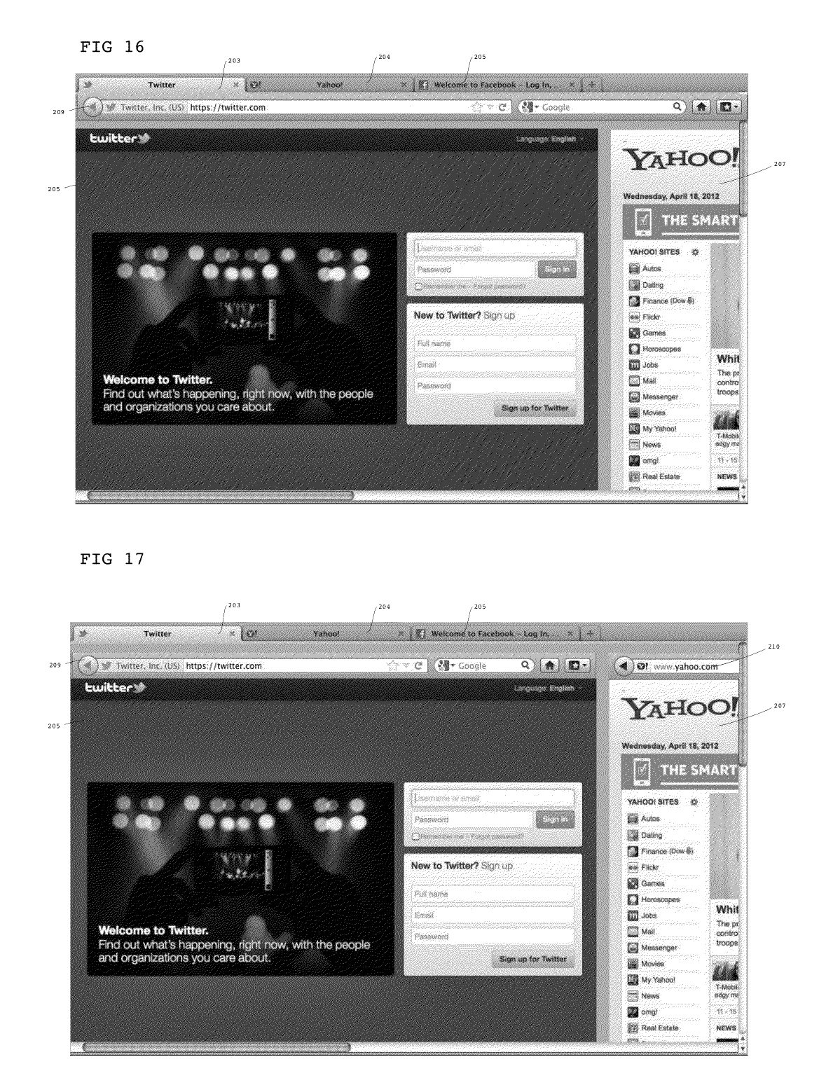

FIG. 16: An embodiment of the invention showing controls located in a single location

FIG. 17: An embodiment of the invention showing controls on each separate inner browser

### DETAILED DESCRIPTION OF THE DRAWINGS

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present embodiment. The following detailed description is, therefore, not to be taken in a limiting sense, and the scope of the present embodiment is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present embodiment.

Referring now to FIG. 7A, we see a beginning state of an embodiment of the invention. In particular, this figure represents a starting state to the embodiment prior to user interaction (such as when the user first arrives.) The present embodiment is shown as functionality contained within an invention-enabled computer software program (web browser).

Primarily, the user is intended to interact with the inner browser 104. The user may enter a web address in the URL box 113 or execute a search in the search area 107. Documents are loaded in the document viewer area 115. Controls typically associated with an internet browser, back/forward/refresh are available 105.

FIG. 7B shows a state of inner browser 104 with a document loaded in viewer area 115. The browser has grown in size to match the dimensions of the loaded document, and thus no scrollbars are needed within the viewer itself. The user may, instead, use the scrollbar on the parent browser 201.

To each side of inner browser 104 are “New Browser” buttons 103. Engaging one of these buttons generates a new inner browser in the position of that button. The new inner browser is in the same style as item 104. Sufficient room is created in the corresponding location to allow for the new inner browser and the overall container expands to fit said inner browser as well.

FIG. 7C shows a continued state from FIG. 7B, wherein two additional inner browsers have been created. Inner browser 130 was created to the right of inner browser 104. In this inner browser, a search was executed from search box 107a, with results showing up in the viewer area below. The “Open links in new viewer” check box 112 is checked-on, meaning that links engaged within the currently viewed document will open in a new inner browser, shown in this embodiment to appear on the right. In the resulting list of search result links, the present figure indicates that the “weathersite.com” link 118 has been engaged. A new inner browser 131 was automatically created to the right of viewer 130, with the document referred to by link 118 loaded in the new inner browser.

Note that each inner browser exists in a separate location in navigation container 132. This area can be scrolled by the parent browser's scrollbar 201 in the same manner as a typical document.

Engaging Minimize buttons 118 in FIG. 7C results in a state represented by FIG. 7D, wherein inner browsers 104 and 130 have been reduced in simple vertical strips 104b and 130b. Document title 114 is rotated on its side to conserve horizontal space. Maximize button 118b can be engaged in order to restore each respective inner browser to it's full size, as shown in FIG. 7C. Close button 119 in any state removes the corresponding inner browser from the scrollable area 132.

FIG. 7E shows an alternate state of FIG. 7C wherein crop button 127 has been engaged on inner browsers 104 and 131. Said inner browsers have been rearranged into a vertically stacked fashion, either automatically or by user action. Engaging “Uncrop” button 128 returns the connected inner browser to its full size. The order of inner browsers are represented by tabs 129. Rearranging tabs causes corresponding inner browsers to reorder to match. Conversely, rearranging inner browsers causes tabs 129 to reorder accordingly. In the shown example, the inner browsers have been rearranged, with ordering following a left-to-right and top-to-bottom sequence.

FIG. 8A presents a state wherein a sample user, Jane Doe 110b, has logged into a personalized version of the present embodiment, which has additional features enabled. A notes field 125, attached to each inner browser, is available for user-entered text notes. A “Save as bookmark” button 124 stores the presently loaded URL to Jane Doe's user account as a record for later access. Bookmark dropdown menu represented in FIG. 8B is accessible via dropdown 123.

In all states, logged-in or not, a “Contents” menu 102 may be available by engaging “Show” button 120, and can be hidden again by engaging Hide button 120b. This menu shows a list of currently active documents 121. Engaging the document name link scrolls the container 132 over until the corresponding inner browser comes into view. Engaging Edit button 126 allows the user to manage inner browsers within the menu to rearrange, minimize, close, or other possible maintenance features. User comments are posted in area 122, allowing multiple people to post their comments relating to this collection.

The “URL for this Collection” button 108 creates a URL reference for the collection. This URL is sufficient to recreate the collection, including open inner browsers and documents, positions, notes and any other relevant setting. To keep the URL short, a URL shortening mechanism may be used, as is known in the art.

The “Share this Collection” 109 button makes it easy for users to inform others about this collection via various social networks and/or communication tools, as are commonly known in the art.

“View as” controls 133 affects how the inner browsers are presented. Currently displayed is “Spread” which means that each inner browser occupies a separate space within navigation container 132. Engaging the “Tabs” button in 133 creates a state as indicated in FIG. 9, wherein each inner browser is now represented as an overlapping tab. The document title 114 is shown in the tab, and the corresponding document is shown in inner browser 134 when that tab is engaged. Engaging the “New Browser” button 103 creates a new tab on top of inner browser 134, whose inner browser represents a new inner browser as in FIG. 7A—104.

FIG. 10 shows an embodiment wherein the invention is shown within a document 101 loaded in a standard or otherwise invention-enabled browser 100. In this case, the same functionality as other embodiments is achieved within the area 132 associated with web page 101.

FIG. 11 shows the related art process for 1) navigating to three example web sites (A, B and C;) 2) using email to share said web pages; and 3) the recipient of said email recreating the browser session wherein web sites A, B and C are displayed.

FIG. 12 shows an embodiment of the process of collecting open websites, browsing data, layout and other metadata as Collection X. In this embodiment, the browser software itself generates a state allowing for the present embodiment to be utilized, such as the creation of a multitude of inner browsers. However, other embodiments could include a document containing said functionality, and Operating System-level function enabling it or other methods not described herein.

Reference to the URL for Collection X are meant to refer to the same functionality as figure reference 108. It should be noted that URLs are not the only method for storing and sharing user collections. Other technologies, including but not limited to computer files or database records could be used instead. It should be noted that while this example uses a manual copy-paste into email as a URL sharing method, there are many other methods of sharing known to the art, including electronic methods such as social networks and automated transmissions, as well as analog methods such as print ads and voice communication. In FIG. 12, Collection X refers to an internet web page that contains functionality of the present embodiment, allowing for the creation of inner browsers. However, this is just one potential embodiment.

FIG. 13 shows a possible embodiment, wherein browsers that have already been opened separately (i.e. not within inner browsers as described within embodiments to the invention) can be combined into a single collection as previously described. By engaging a “Collection” function, the URLs of web pages contained in a specified set of open browsers would be recorded as well as other metadata as needed. A new collection, such as is shown in FIG. 7C would be generated, containing a number of inner browsers, each displaying a corresponding web page from previously the recorded URLs. In a potential further embodiment, the previously open browsers would close, leaving only a browser containing the new collection.

FIG. 14 shows a reverse of FIG. 13, wherein a “Convert to Documents” function is initiated on a previously created collection. If said function is initiated on a “standard” browser (or other environment), then as many features of the collection are engaged as is possible with the technology available. The term “standard” here means “not containing some or any embodiments of the invention.” For example, when initiated in a standard browser, URLs contained in said collection are launched in a new (separate) browser tabs or windows.

If the collection is accessed in an invention-enabled browser or environment, the system allows for recreation of the Collection. This includes, but is not limited to recreation of the layout of browsers and documents loaded therein. In another embodiment, the collection would allow for personalized data, such as title and notes, to be recreated.

FIG. 15 shows a 4-step illustration of how an embodiment of the invention might handle the functionality of tabs in relation to the navigation pane. The figures are all different states in time of the same embodiment, shown as a browser with three inner browsers displaying Twitter.com 206, Yahoo.com 207 and Facebook.com 208 in that order. The tabs at the top 203, 204, 205 correspond to the shown inner browsers in that order. Tab 203 is shown as active, in this example because Twitter.com 206 is closest to the center of the view.

FIG. 15-A shows the mouse cursor 202 engaging with scroll control 201 of the navigation container. The user clicks the mouse button and holds and drags scroll control 201 to the right, thus scrolling the contents of the navigation container. FIG. 15-B shows the scroll control 201 in the middle of the available scroll track, thus indicating that the navigation container has traveled half way. While dragging the scroll control 201, the inner browsers move in synch with the navigation container until the inner browser containing Yahoo.com 207 is centered in view. Notice also that the tab associated with this inner browser, tab 204, is now shown as activated. Tab 203, which was previously active, is now deactivated. The edge of the third website 208 is visible on the right side of the navigation container. For the next step in this sequence, the user continues to drag scroll control 201 to the right, bringing Facebook.com 208 into full view shown in FIG. 15-C. Tab 205, relating to inner browser 208 is now the only one active. FIG. 15-D shows a reverse of the previously described control that the scroll controller has over the state of the tabs. In this example, the user has clicked mouse cursor 202 on tab 203. This activates tab 203. This controls scroll control 201 so that Twitter.com's inner browser 205 comes into full view. Notice that scroll control 201 is now all the way to the left of the track. In such a manner, the tabs may affect what is visible in the navigation container.

FIG. 16 shows an embodiment of the invention where controls for the individual inner browsers are fixed in a single location 209. The tab for Twitter.com 203 is currently shown as being active, and the URL for Twitter.com is currently shown in the centralized control area. In this example, the other controls would also affect the inner browser containing Twitter.com. Should the user engage another tab, such as 204 or 205, the centralized controls would switch in scope to dislay that URL and control that corresponding inner browser. For example, clicking on tab 204 would activate the tab. The URL control would change to say “yahoo.com” and the other controls would switch their target to start controlling the inner browser for the Yahoo website.

FIG. 17 shows an embodiment of the invention in which controls exist on or near each individual inner browser. For example, controls 209 affect the connected inner browser 205. We see Twitter.com displayed in the URL bar, and Twitter.com is loaded into that inner browser. The remainder of the controls would largely control only inner browser 205. The neighboring inner browser 207 is controlled by its connected controls 210. Indeed, we see www.yahoo.com loaded in the URL address bar, and the Yahoo.com webite displayed in inner browser 207.

### PATENT CITATIONS

U.S. Pat. No. 7,730,082
Sah, et al. Jun. 1, 2010 (Google)
Remote module incorporation into a container document
U.S. Pat. No. 7,743,334
Rider Jun. 22, 2010 (Microsoft)
Dynamically configuring a web page (HTTPXML configuration)
United States Patent Application 20110055685
Kind Code A1
Jaquish; Matthew; et al. Mar. 3, 2011
SYSTEM AND METHOD TO PROVIDE A DOMAIN SPLIT DISPLAY
U.S. Pat. No. 6,031,989
Cordell Feb. 29, 2000
Method of formatting and displaying nested documents
U.S. Pat. No. 7,818,677
Ruthfield, et al. Oct. 19, 2010
Single window navigation methods and systems
U.S. Pat. No. 7,194,743
Hayton, et al. Mar. 20, 2007
Methods and apparatus for communicating changes between a user interface and an executing application using property paths
U.S. Pat. No. 6,658,419
Pasquali Dec. 2, 2003
System and method for facilitating a windows based content manifestation environment within a WWW browser
United States Patent Application 20110145757
Kind Code A1
Janwari; Fida Jun. 16, 2011
Scrolling Control and Communication Control Applications and Methods
United States Patent Application 20100179949
Kind Code A1
SAFAR; SAMIR H. Jul. 15, 2010
METHOD AND SYSTEM FOR AN INTERNET BROWSER ADD-ON PROVIDING SIMULTANEOUS MULTIPLE INTERACTIVE WEBSITES ON ONE INTERNET BROWSER WINDOW
United States Patent Application 20100161586
Kind Code A1
Safar; Samir H. Jun. 24, 2010
SYSTEM AND METHOD OF MULTI-PAGE DISPLAY AND INTERACTION OF ANY INTERNET SEARCH ENGINE DATA ON AN INTERNET BROWSER
United States Patent Application 20060224951
Kind Code A1
Burke; Eric Paul; et al. Oct. 5, 2006
Multiple window browser interface and system and method of generating multiple window browser interface
United States Patent Application 20060150094
Kind Code A1
Patrawala; Zakir Jul. 6, 2006
Web companion (Portal Channel page)

1. A system which includes a navigation container into which a multitude of inner browsers may be placed;

2. The system of claim 1, further including a method for storing the state of said system.
